(19) United States
(12) Patent Application Publication
(10) Pub. No.: US 2009/0061955 A1
(43) Pub. Date: Mar. 5, 2009

(54) POWER SAVING SYSTEM AND METHOD FOR A MOBILE PHONE

(75) Inventor: Po-Hua Huang, Tu-Cheng (TW)

Correspondence Address: PCE INDUSTRY, INC.;ATT. CHENG-JU CHIANG, 458 E. LAMBERT ROAD, FULLERTON, CA, 92835, US

(73) Assignee: CHI MEI COMMUNICATION SYSTEMS, INC., Tu-Cheng City (TW)

(21) Appl. No.: 11/957,497

(22) Filed: Dec. 17, 2007

(30) Foreign Application Priority Data
Aug. 28, 2007 (CN) 200710201506.9

(51) Int. Cl. H04B 1/38; G09G 5/00

(52) U.S. Cl. 455/574; 345/204

(57) ABSTRACT

A power saving method for a mobile phone includes the steps of: setting a standard brightness range, wherein the standard brightness range comprises a maximum value and a minimum value; opening a camera (11); measuring an ambient brightness; determining whether the measured ambient brightness is less than the minimum value; turning on a keypad LED (12) and decreasing the brightness of a liquid crystal module (13) if the measured ambient brightness is less than the minimum value; or turning off the keypad LED if the measured ambient brightness is not less than the minimum value; determining whether the measured ambient brightness is more than the maximum value; and increasing the brightness of the liquid crystal module if the measured ambient brightness is more than the maximum value. A power saving system for a mobile phone is also provided.

### BACKGROUND OF THE INVENTION

1. Field of the Invention

The present invention generally relates to power saving systems and methods for a mobile phone.

2. Description of related art

Nowadays, mobile phones are being widely used by more and more people. Because of their small sizes and low weights, the mobile phones are easy to carry. Moreover, by continually improving the signal strength and the coverage area, the mobile phones offer wider and better service. Along with technology rapid development, features or functions are being added to mobile phones. Features such as camera, handwriting recognition, and temperature measurement are common on mobile phones. Nevertheless, the stand-by time of the battery of the mobile phone has not yet been improved with the pace of the other features, for example, most batteries of mobile phones only have two or three days of stand-by time.

Generally, the liquid crystal module of the mobile phone must be bright enough to ensure that characters on the screen of the mobile phone can be clearly seen outdoors. However, the brighter the screen the more the power consumption and less talk (or stand-by) time of the mobile phone.

Accordingly, what is needed is a power saving system and method, for a mobile phone, which can automatically adjust the brightness of the liquid crystal module of the mobile phone.

### SUMMARY OF THE INVENTION

One preferred embodiment provides a power saving system for a mobile phone. The mobile phone includes a camera, a keypad LED and a liquid crystal module. The system includes a brightness setting module, a camera controlling module, a brightness measuring module, a brightness determining module, a brightness controlling module and a keypad LED controlling module. The brightness setting module is configured for setting a standard brightness range, wherein the standard brightness range comprises a maximum value and a minimum value. The camera controlling module is configured for opening the camera. The brightness measuring module is configured for measuring an ambient brightness through the camera. The brightness determining module is configured for comparing the measured ambient brightness with the standard brightness range. The brightness controlling module is configured for decreasing the brightness of the liquid crystal module if the measured ambient brightness is less than the minimum value of the standard brightness range, and for increasing the brightness of the liquid crystal module if the measured ambient brightness is more than the maximum value of the standard brightness range. The keypad LED controlling module is configured for turning on the keypad LED if the measured ambient brightness is less than the minimum value of the standard brightness range, and turning off the keypad LED if the measured ambient brightness is not less than the minimum value of the standard brightness range.

Another preferred embodiment provides a power saving method for a mobile phone. The mobile phone includes a camera, a keypad LED and a liquid crystal module. The method comprising the steps of: (a) setting a standard brightness range, wherein the standard brightness range comprises a maximum value and a minimum value; (b) opening the camera; (c) measuring an ambient brightness through the camera; (d) determining whether the measured ambient brightness is less than the minimum value of the standard brightness range; (e1) turning on the keypad LED and decreasing the brightness of the liquid crystal module if the measured ambient brightness is less than the minimum value of the standard brightness range; or (e2) turning off the keypad LED if the measured ambient brightness is not less than the minimum value of the standard brightness range, wherein step (e2) comprises the steps of: (e20) determining whether the measured ambient brightness is more than the maximum value of the standard brightness range; and (e21) increasing the brightness of the liquid crystal module if the measured ambient brightness is more than the maximum value of the standard brightness range.

Other systems, methods, features, and advantages will be or become apparent to one skilled in the art upon examination of the following drawings and detailed description.

### BRIEF DESCRIPTION OF THE DRAWINGS

FIG. 1 is a block diagram of an application of a power saving system for a mobile phone in accordance with one preferred embodiment.

FIG. 2 is a flowchart of a power saving method for a mobile phone in accordance with the preferred embodiment.

### DETAILED DESCRIPTION OF THE INVENTION

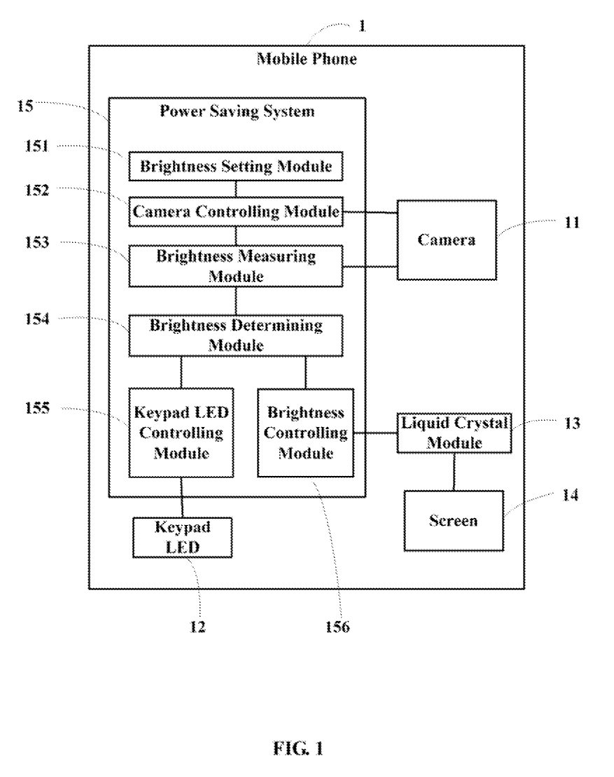

FIG. 1 is a block diagram of an application of a power saving system for a mobile phone (hereinafter “the power saving system”) in accordance with one preferred embodiment. The power saving system 15 is incorporated in a mobile phone 1. The mobile phone 1 typically includes a camera 11, a keypad light-emitting diode (LED) 12, a liquid crystal module 13, and a screen 14 connected to the liquid crystal module 13. The system 15 includes a brightness setting module 151, a camera controlling module 152, a brightness measuring module 153, a brightness determining module 154, a keypad LED controlling module 155, and a brightness controlling module 156.

The brightness setting module 11 is configured for setting a standard brightness range. The standard brightness range includes a maximum value and a minimum value. For example, the standard brightness range may be set as a range of indoor brightness in the daytime, or a range of outdoor brightness in the daytime. In the preferred embodiment, the standard brightness range is set as 20-100 lumen per square meter (lm/m2).

The camera controlling module 152 is connected with the camera 11 and is configured for opening the aperture of the camera 11 at intervals of one minute when the mobile phone 1 is in use. The intervals of one minute is only an example in the preferred embodiment, in other embodiments, the intervals for opening the camera 11 may be set or adjusted according to the actual requirements by the controlling module 152.

The brightness measuring module 153 is connected with the camera 11 and is configured for measuring an ambient brightness. The brightness measuring module 153 measures the ambient brightness by using an automatic exposure mode of the camera 11. Under the automatic exposure mode, the brightness measuring module 153 measures the ambient brightness according to brightness of the light rays entering the camera 11.

The brightness determining module 154 is configured for comparing the measured ambient brightness with the standard brightness range, determining whether the measured ambient brightness is less than the minimum value of the standard brightness range, and determining whether the measured ambient brightness is more than the maximum value of the standard brightness range.

The keypad LED controlling module 155 is connected with the keypad LED 12 and is configured for turning on the keypad LED 12 if the measured ambient brightness is less than the minimum value of the standard brightness range, and turning off the keypad LED 12 if the measured ambient brightness is not less than the minimum value of the standard brightness range.

The brightness controlling module 156 is connected with the liquid crystal module 13 and is configured for decreasing the brightness of the liquid crystal module 13 if the measured ambient brightness is less than the minimum value of the standard brightness range. The brightness controlling module 156 is further configured for increasing the brightness of the liquid crystal module 13 if the measured ambient brightness is more than the maximum value of the standard brightness range, so as to increase the brightness of the screen 14.

The camera controlling module 152 is further configured for closing the aperture of the camera 11.

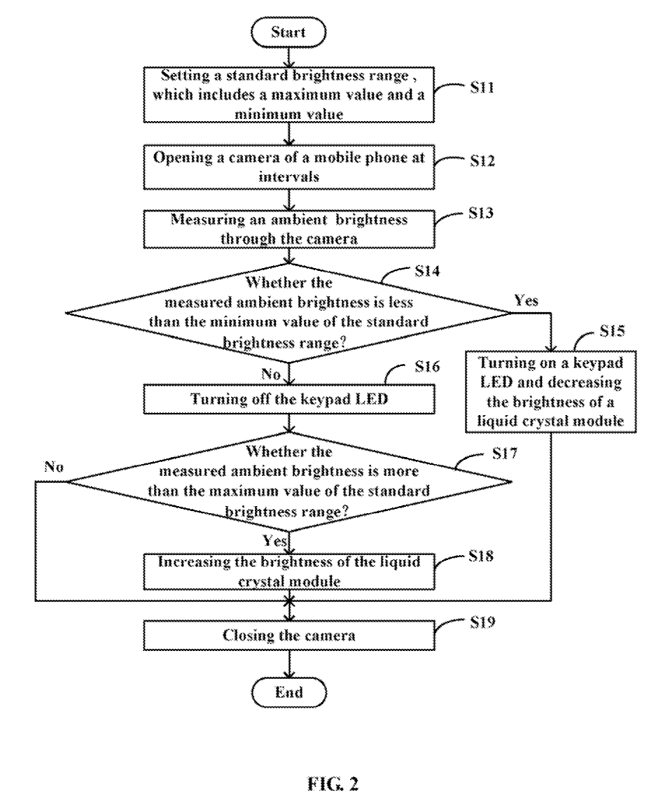

FIG. 2 is a flowchart of a power saving method for a mobile phone in accordance with the preferred embodiment.

In step S11, the brightness setting module 11 sets the standard brightness range. The standard brightness range includes the maximum value and the minimum value.

In step S12, the camera controlling module 152 opens the aperture of the camera 11 at intervals of one minute when the mobile phone 1 is in use. The intervals of one minute is only an example in the preferred embodiment, in other embodiments, the intervals for opening the camera 11 may be set or adjusted according to the actual requirements by the controlling module 152.

In step S13, the brightness measuring module 153 measures the ambient brightness through the camera 11 according to the brightness of the light rays entering the camera 11.

In step S14, the brightness determining module 154 determines whether the measured ambient brightness is less than the minimum value of the standard brightness range.

If the measured ambient brightness is less than the minimum value of the standard brightness range, in step S15, the keypad LED controlling module 155 turns on the keypad LED 12, and the brightness controlling module 156 decreases the brightness of the liquid crystal module 13, and then the procedure directly goes to step S19.

If the measured ambient brightness is not less than the minimum value of the standard brightness range, in step S16, the keypad LED controlling module 155 turns off the keypad LED 12.

In step S17, the brightness determining module 154 determines whether the measured ambient brightness is more than the maximum value of the standard brightness range.

If the measured ambient brightness is more than the maximum value of the standard brightness range, in step S18, the brightness controlling module 156 increases the brightness of the liquid crystal module 13 so as to increases the brightness of the screen 14. Otherwise, if the measured ambient brightness is not more than the maximum value of the standard brightness range, the procedure directly goes to step S19.

In step S19, the camera controlling module 152 closes the aperture of the camera 11.

It should be emphasized that the above-described embodiments of the preferred embodiments, particularly, any “preferred” embodiments, are merely possible examples of implementations, merely set forth for a clear understanding of the principles of the invention. Many variations and modifications may be made to the above-described preferred embodiment(s) without departing substantially from the spirit and principles of the invention. All such modifications and variations are intended to be included herein within the scope of this disclosure and the above-described preferred embodiment(s) and protected by the following claims.

What is claimed is:

1. A power saving system for a mobile phone, the mobile phone comprising a camera, a keypad LED, and a liquid crystal module, the power saving system comprising:
a brightness setting module configured for setting a standard brightness range, wherein the standard brightness range comprises a maximum value and a minimum value;
a camera controlling module configured for opening the camera;
a brightness measuring module configured for measuring an ambient brightness through the camera;
a brightness determining module configured for comparing the measured ambient brightness with the standard brightness range;
a brightness controlling module configured for decreasing the brightness of the liquid crystal module if the measured ambient brightness is less than the minimum value of the standard brightness range, and for increasing the brightness of the liquid crystal module if the measured ambient brightness is more than the maximum value of the standard brightness range; and
a keypad LED controlling module configured for turning on the keypad LED if the measured ambient brightness is less than the minimum value of the standard brightness range, and turning off the keypad LED if the measured ambient brightness is not less than the minimum value of the standard brightness range.

2. The power saving system according to claim 1, wherein the camera controlling module is further configured for closing the camera after the keypad LED controlling module and the brightness controlling module have finished corresponding controlling.

3. A power saving method for a mobile phone, the mobile phone comprising a camera, a keypad LED and a liquid crystal module, the power saving method comprising the steps of:
(a) setting a standard brightness range, wherein the standard brightness range comprises a maximum value and a minimum value;
(b) opening the camera;
(c) measuring an ambient brightness through the camera;
(d) determining whether the measured ambient brightness is less than the minimum value of the standard brightness range;
(e1) turning on the keypad LED and decreasing the brightness of the liquid crystal module if the measured ambient brightness is less than the minimum value of the standard brightness range; or
(e2) turning off the keypad LED if the measured ambient brightness is not less than the minimum value of the standard brightness range, wherein step (e2) comprises the steps of:
(e20) determining whether the measured ambient brightness is more than the maximum value of the standard brightness range; and
(e21) increasing the brightness of the liquid crystal module if the measured ambient brightness is more than the maximum value of the standard brightness range.

4. The method according to claim 3, wherein step (e1) comprises the step of closing the camera.

5. The method according to claim 3, wherein step (e21) comprises the step of closing the camera.

6. The method according to claim 3, wherein step (e2) further comprises the step of:
(e22) closing the camera if the measured ambient brightness is not more than the maximum value of the standard brightness range.
